(19) United States
(12) Patent Application Publication
(10) Pub. No.: US 2026/0004062 A1
(43) Pub. Date: Jan. 1, 2026

(54) SYSTEMS AND METHODS FOR SUSTAINABILITY PERFORMANCE BENCHMARKING

(71) Applicant: Schlumberger Technology Corporation, Sugar Land, TX (US)

(72) Inventor: Nader Salman, Houston, TX (US)

(21) Appl. No.: 19/047,315

(22) Filed: Feb. 6, 2025

Related U.S. Application Data
(60) Provisional application No. 63/665,577, filed on Jun. 28, 2024.
(60) Provisional application No. 63/665,998, filed on Jun. 28, 2024.
(60) Provisional application No. 63/665,663, filed on Jun. 28, 2024.
(60) Provisional application No. 63/665,975, filed on Jun. 28, 2024.

(51) Int. Cl. G06F 40/20; G06F 9/451; G06F 40/186

(52) U.S. Cl. CPC G06F 40/20; G06F 9/451; G06F 40/186

(57) ABSTRACT

A tangible, non-transitory, computer-readable medium includes instructions that, when executed by processing circuitry, are configured to cause the processing circuitry to transmit a set of sustainability data to a computer vision model for extraction into a textualized set of sustainability data, divide the textualized set of sustainability data into one or more subsets of textualized sustainability data, transmit the one or more subsets of textualized sustainability data to an artificial intelligence (AI) model, transmit at least one instruction to the AI model to elicit summarization the one or more subsets of textualized sustainability data into a summarized dataset, and transmit at least one instruction to the AI model to cause generation of a sustainability dashboard comprising at least one metric selected from the summarized dataset.

### CROSS REFERENCE TO RELATED APPLICATIONS

This application is a Non-Provisional Application claiming priority to U.S. Provisional Patent Application No. 63/665,577, entitled “SYSTEMS AND METHODS FOR SUSTAINABILITY PERFORMANCE BENCHMARKING,” filed Jun. 28, 2024, claiming priority to U.S. Provisional Patent Application No. 63/665,998, entitled, “SYSTEMS AND METHODS FOR SUSTAINABILITY DATA INTEGRATION AND VISUALIZATION,” filed Jun. 28, 2024, claiming priority to U.S. Provisional Patent Application No. 63/665,663, entitled, “SYSTEMS AND METHODS FOR SUSTAINABILITY DATA NAVIGATION,” filed Jun. 28, 2024, claiming priority to U.S. Provisional Patent Application No. 63/665,975, entitled, “SYSTEMS AND METHODS FOR SUSTAINABILITY REPORT GENERATION,” filed Jun. 28, 2024, which is herein incorporated by reference.

### BACKGROUND

The present disclosure generally relates to systems and methods for benchmarking sustainability performance of one or more entities.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Generally, entities are becoming increasingly interested in contributing to a sustainable future, addressing environmental concerns, and/or identifying where other entities stand regarding their sustainability commitments. In particular, the entities may be interested in collecting comprehensive sustainability data from a variety of sources. However, it may be difficult to retrieve, manage, and/or summarize the sustainability data due to large volume and/or complexity of the sustainability data. Further, visualization of the sustainability data by a user may be inefficient. Thus, it may be desired to improve sustainability data management, summarization, and/or visualization.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a tangible, non-transitory, computer-readable medium includes instructions that, when executed by processing circuitry, are configured to cause the processing circuitry to transmit a set of sustainability data to a computer vision model for extraction into a textualized set of sustainability data, divide the textualized set of sustainability data into one or more subsets of textualized sustainability data, transmit the one or more subsets of textualized sustainability data to an artificial intelligence (AI) model, transmit at least one instruction to the AI model to elicit summarization the one or more subsets of textualized sustainability data into a summarized dataset, and transmit at least one instruction to the AI model to cause generation of a sustainability dashboard including at least one metric selected from the summarized dataset.

In an embodiment, a method includes transmitting, via processing circuitry, a set of sustainability data to a computer vision model for extraction into a textualized set of sustainability data, dividing, via the processing circuitry, the textualized set of sustainability data into one or more subsets of textualized sustainability data, and transmitting, via the processing circuitry, the one or more subsets of textualized sustainability data to an artificial intelligence (AI) model. The method also includes transmitting, via the processing circuitry, at least one instruction to the AI model to elicit summarization of the one or more subsets of textualized sustainability data into a summarized dataset, and transmitting, via the processing circuitry, at least one instruction to the AI model to cause generation of a sustainability dashboard by the AI model as a graphical user interface on a display utilizing the summarized dataset, wherein the sustainability dashboard includes at least one metric selected from the summarized dataset.

In an embodiment, a system includes processing circuitry configured to transmit a set of sustainability data received from one or more data sources to a computer vision model for extraction into a textualized set of sustainability data, divide the textualized set of sustainability data into one or more subsets of textualized sustainability data, and transmit the one or more subsets of textualized sustainability data to an artificial intelligence (AI) model. The processing circuitry also configured to transmit at least one instruction to the AI model to elicit summarization the one or more subsets of textualized sustainability data into a summarized dataset and transmit at least one instruction to the AI model to cause generation of a sustainability dashboard including at least one metric selected from the summarized dataset.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a flow diagram of processes performed in the benchmarking system, in accordance with an embodiment of the present disclosure;

FIG. 2 is a flowchart of a method for providing a summarized one or more subsets of sustainability data for processing, in accordance with an embodiment of the present disclosure;

FIG. 3 is a flowchart of a method for generating a sustainability dashboard, in accordance with an embodiment of the present disclosure; and

FIG. 4 is an example illustration of the sustainability dashboard, in accordance with an embodiment of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

The present embodiments described herein include a benchmarking system (e.g., a sustainability benchmarking system), which benchmarks sustainability performance of one or more entities by retrieving, extracting, splitting and summarizing, and/or processing a set of sustainability data. The benchmarking system retrieves (e.g., receives, fetches) the set of sustainability data from one or more of a variety of data sources (e.g., one or more web links, application programming interfaces (API), one or more databases, etc.) associated with the one or more entities. This retrieval can be repeated for additional entities. The set of sustainability data may be associated with one or more sustainability metrics of each respective data source. For example, the benchmarking system may receive one or more portable document formats (PDFs) associated with a sustainability report for each respective data source (e.g., each respective entity). Further, the benchmarking system may continuously monitor the one or more data sources for updates to the set of sustainability data, ensuring the set of sustainability data maintains relevance. The benchmarking system may then extract relevant information from the set of sustainability data. As an example, the benchmarking system may employ a vision model to process text and/or one or more images and integrate visual features with text processing capabilities to extract relevant text and/or image descriptions. Additionally and/or alternatively, optical character recognition (OCR) can be utilized to identify relevant text and/or images and extract the relevant text and/or images.

Moreover, the benchmarking system may split (e.g., divide) the extracted set of sustainability data into one or more subsets of sustainability data and assign an identifier to each of the one or more subsets of sustainability data based on an associated data source. The benchmarking system may then summarize the one or more subsets of sustainability data based on a template (e.g., a set of sequenced questions, instructions, or the like). In some embodiments, the template may be based on one or more standards (e.g., one or more industry standards). In other embodiments, the user may customize the template via one or more user inputs. In this manner, implementation of the template may enable a user-guided bias toward specific data types. As such, the benchmarking system may pre-process the sustainability data via retrieval, extraction, and split and summarization and provide the one or more subsets of data for processing.

The benchmarking system may process the one or more subsets of sustainability data via an artificial intelligence (AI) engine and based on one or more user inputs and/or an additional template. Further, the benchmarking system may receive a request to generate a sustainability dashboard. In some embodiments, the benchmarking system may receive the one or more user inputs selecting one or more sustainability dashboard parameters (e.g., sustainability metrics). Thus, the benchmarking system may generate the sustainability dashboard based on the one or more subsets of sustainability data, the template, and the one or more user inputs. The benchmarking system may then present the sustainability dashboard for visualization. In this manner, the benchmarking system may improve sustainability data management, summarization, and/or visualization by efficiently gathering, summarizing, and/or presenting the sustainability data.

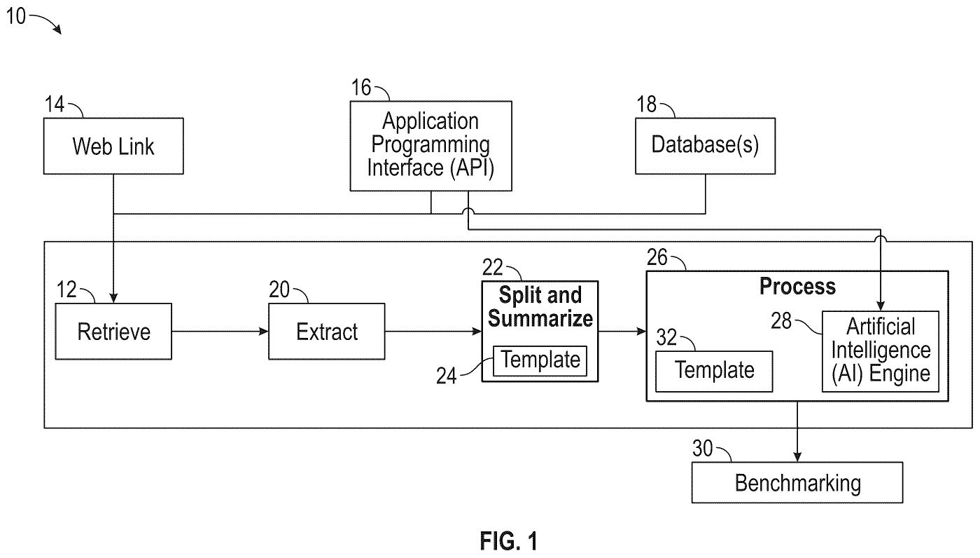

With the foregoing in mind, FIG. 1 is a flow diagram of processes performed in a benchmarking system 10, in accordance with an embodiment of the present disclosure. In some embodiments, the benchmarking system 10 may include a processing device (e.g., processing circuitry, processing system) with at least a processor capable of executing computer-executable code to perform the operations described below. The processing device of the benchmarking system 10 may operate in conjunction with a deep-learning processor or a neural-network processor and/or, for example, the processing device may include machine learning and/or artificial intelligence (AI)-based processors.

For example, in one or more embodiments, a deep-learning processor or a neural-network processor, and/or, for example a machine learning (ML) and/or AI based processor of the benchmarking system can execute instructions stored in memory and/or storage of the benchmarking system as one or more analysis modules to execute one or more of the operations described herein. Likewise, the operations described herein may be instituted via a processing device (e.g., processing circuitry, processing system) with at least a processor capable of executing computer-executable code to perform the operations described herein via a local computing device and the AI functions described herein can be performed on a server or in the cloud as coupled to the local computing device of the benchmarking system. In some embodiments, a processing device of the benchmarking system 10 may operate in conjunction with a deep-learning processor or a neural-network processor and/or, for example, the processing device may include machine learning and/or artificial intelligence (AI)-based processors.

Therefore, the AI may be integrated into the benchmarking system 10 (or remotely coupled thereto) and can operate as a component that utilizes algorithms and/or models interconnected with other components of the benchmarking system 10. In some embodiments, the AI may function separately (e.g., independently) from the benchmarking system 10. Further, the AI may be coupled to the benchmarking system 10 via a cloud (e.g., a cloud-based integration) enabling utilization of the algorithms and/or the models hosted remotely on the cloud. The benchmarking system 10 may also include memory and/or storage, which may be any suitable articles of manufacture that serve as media to store processor-executable code, data, or the like. These articles of manufacture may represent computer-readable media (e.g., any suitable form of memory or storage) that may store processor-executable code used by the processor to perform the below noted techniques. It should be noted that the benchmarking system 10 may perform at least some of the processes described herein in parallel (e.g., simultaneously) or at separate times.

In block 12, the benchmarking system 10 may retrieve a set of sustainability data from one or more data sources associated with one or more entities. The set of sustainability data may be associated with one or more sustainability metrics of each respective entity of the one or more entities. For example, the one or more entities may include companies in the oil and gas industry, companies in the construction industry, companies in the cement industry, companies in manufacturing industry, or any other companies tracking sustainability goals. The one or more data sources may include one or more web links 14, one or more application programming interfaces 16 (APIs), and/or one or more databases 18. The one or more web links 14 may be associated with a web page, an online platform, or an Internet site of each respective entity (e.g., company). As an example, the benchmarking system 10 may receive one or more portable document formats (PDFs) associated with a sustainability report for each respective data source (e.g., each respective entity) via the one or more web links 14. It should be noted that the benchmarking system 10 may employ web scraping regularly (e.g., continuously, at intervals) automatically and/or at one or more defined times (e.g., predetermined scheduled times, which can be set by a user or automatically generated) to retrieve data from the one or more web links 14 (as well as the APIs 16, and/or the one or more databases 18).

The retrieval of data from the one or more web links 14, the APIs 16, and/or the one or more databases 18 can be in response to a request from the benchmarking system 10 and refresh operations (i.e., scheduled retrievals of data from the one or more web links 14, the APIs 16, and/or the one or more databases 18) can be performed at the same frequency or at differing frequencies relative to one another. For example, the benchmarking system 10 may employ web scraping to enable use of sustainability data that is up-to-date (e.g., current). Additionally, for example, the benchmarking system 10 may employ a minimum refresh frequency of the one or more web links 14 (and/or the APIs 16, and/or the one or more databases 18) at least once annually or any other suitable time period (e.g., weekly, monthly), whereby the refresh frequencies may be common between the one or more web links 14, the APIs 16, and/or the one or more databases 18 or may differ therebetween.

The one or more APIs 16 may each be associated with a respective entity of the one or more entities and may enable a number of software systems to communicate with the one or more APIs 16 to request/retrieve data. Thus, the benchmarking system 10 may request and/or receive data from any number of entities via the APIs 16. The one or more databases 18 may include data associated with the one or more entities and/or one or more industry standards. As an example, the one or more entities may assemble (e.g., compile, organize) the one or more databases 18 and provide the one or more databases 18 to the benchmarking system 10. As another example, the one or more databases 18 may include one or more public document repositories and/or one or more correlations between a number of entities. It should be noted that while the benchmarking system 10 is described as retrieving the set of sustainability data via the one or more web links 14, the APIs 16, and/or the one or more databases 18, the benchmarking system 10 may retrieve data via any suitable data source. In addition, it should be noted that the benchmarking system 10 may retrieve data from internal sources (e.g., an entity associated with the user) and/or, for example, any external entity, for example, via the one or more databases 18.

In block 20, the benchmarking system 10 may extract relevant information, such as particular sustainability metrics, from the set of sustainability data. Examples of types of relevant information and/or sustainability metrics can include one or more of, for example, net-zero scope target one, scope target two, and/or scope target 3 (e.g., their respective target dates), methane targets, flaring targets, sustainability budgets, methane migration protocols, local carbon regulation regions, investment review processes, leaders of the sustainability groups of the entities, budget leaders for sustainability programs, membership in sustainability organizations, product carbon intensity goals, reporting standards, and/or other sustainability metrics. This data (i.e., the relevant information) can be selected from predetermined types of data based on what information is to be represented in the final compiled benchmark dashboard, for example. The extraction of the relevant data can be accomplished via a command transmitted to the program or an AI model trained to detect objects, for example, in images (e.g., a computer vision model). Additionally and/or alternatively, the extraction of the relevant data can be accomplished via an executed code that instructs the computer vision model to extract the relevant information, for example, through the use of a template (e.g., a set of sequenced questions, instructions, or the like) generated for the particular relevant information extraction.

In this manner, the relevant information may include at least a portion of the set of sustainability data. That is, the benchmarking system 10 may extract relevant text and/or images from the set of sustainability. To assist in accomplishing the extraction, the benchmarking system 10 may employ as noted above, for example, a computer vision model, which may process images using deep learning techniques (e.g., a neural network or AI on a local device of the benchmarking system or connected thereto and hosted in a remote server, in the cloud, etc.) to extract one or more features from each sustainability report and provide, for example an ASCII (e.g., textual version) of the retrieved sustainability data from block 12. As another example, the benchmarking system 10 may employ a computer-based vision technique, such as optical character recognition (OCR) to extract images and/or text from each sustainability report associated with each respective entity. Additionally or alternatively, the benchmarking system 10 may apply OCR to extract a textual version of each sustainability report associated with each respective entity. After extraction of the relevant information from the set of sustainability data, the benchmarking system 10 may assemble (e.g., compile, combine) the extracted set of sustainability data into a textual format.

In block 22, the benchmarking system 10 may split and summarize the extracted set of sustainability data. For example, the benchmarking system 10 may employ a computer algorithm that splits and separates each sustainability report included in the set of sustainability data while maintaining consistency (e.g., organization) of each split portion of each sustainability report. The benchmarking system 10 may employ a computer algorithm that directs an AI system to split and separate each sustainability report included in the set of sustainability data while maintaining consistency (e.g., organization) of each split portion of each sustainability report. That is, to split the extracted set of sustainability data, the benchmarking system 10 may divide the extracted set of sustainability data into one or more subsets of sustainability data (e.g., one or more portions of each sustainability report). The benchmarking system 10 may split the extracted set of sustainability data based on a maximum capacity of an AI model. As an example, each sustainability report may include a respective number of tokens, for example, that represent characters, punctuation, and the like of a dataset to be transmitted to the AI model. Moreover, the maximum capacity of the AI model may include a set number of tokens, for example, one-hundred thousand tokens. Thus, if the set of sustainability data includes twelve sustainability reports, then the benchmarking system 10 may split the twelve sustainability reports so that they may be summarized into a complete dataset such that the size of that dataset does not exceed the one-hundred thousand tokens, with the relevant information from each split report being tagged so that when the dataset is compiled, the data from any one report is correlated in the dataset to the correct report from which it was split and summarized.

In some embodiments, the benchmarking system 10 may assign an identifier to each of the one or more subsets of sustainability data based on an associated data source (e.g., an associated entity). For example, the benchmarking system 10 may assign a respective identifier to each of the one or more subsets of sustainability data based on an entity, an industry, and/or history associated with each of the one or more subsets of sustainability data. It should be noted that the identifiers may be identical, a portion of the identifiers may be identical, or each identifier may be entirely distinct (e.g., different). For example, one portion of the one or more subsets of sustainability data may be associated with a particular entity, a particular report, and/or a particular industry. Thus, for example, the identifier for that entity identifying the data as corresponding to a data source for that entity can be applied to all split data from a report for that entity to track the splits of data. Likewise, another portion of the one or more subsets of sustainability data may be associated with another particular entity, a particular report, and/or a particular industry. Thus, a different identifier for that other entity identifying the data as corresponding to a data source for that other entity can be applied to all split data from a report for that other entity to track the splits of data.

In this manner, the benchmarking system 10 may reduce an output size of the extracted set of sustainability data during the split and summarize process for input into an AI model (e.g., generative AI model), such as a Retrieval-Augmented Generation (RAG) model, while also maintaining organization when storing the extracted set of sustainability data (e.g., in a memory of the benchmarking system 10 or any other suitable memory). For example, the benchmarking system 10 may reduce the output size to the number of tokens manageable by the RAG model.

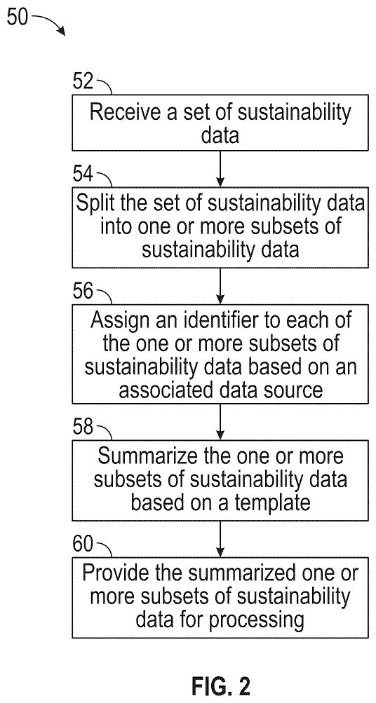

To summarize the extracted set of sustainability data, the benchmarking system 10 may employ an AI model (e.g., a generative model) or an algorithm to perform summarization tasks. For example, the benchmarking system 10 may employ the AI model to perform searching on the extracted set of sustainability data and summarize the extracted set of sustainability data based on a predetermined token size. The benchmarking system 10 may perform summarization based on a template 24. It should be noted that the template 24 may include processor-executable code that may be executed by the processor device of the benchmarking system 10 to direct the AI model to split the extracted set of sustainability data and/or to summarize the one or more subsets of sustainability data for each sustainability report. As such, the benchmarking system 10 may employ the template 24 to generate the summarized one or more subsets of sustainability data. As an example, the template 24 may be customized based on the one or more user inputs that specify a type of data to be summarized. In some embodiments, the user may run one or more queries via a customized template 24. Additional details with regard to block 22 will be described below with respect to FIG. 2.

In block 26, the benchmarking system 10 may process the one or more subsets of sustainability data via an AI engine 28 (e.g., AI system), which may employ an AI model (e.g., the same AI model described above with respect to block 22 or a separate AI model with both or either local to the computing device of the benchmarking system 10 or remotely connected thereto and present in a server, the cloud, or the like). In one embodiment, the benchmarking system 10 may input the one or more subsets of sustainability data into the AI engine 28 to adjust (e.g., refine, fine-tune) the AI model based on the one or more subsets of sustainability data and/or enable query of the one or more subsets of sustainability data. Accordingly, the benchmarking system 10 may provide an output via the AI engine 28 in a format that aligns with requested (e.g., desired) output parameters for a model optimization scheme. Indeed, the output parameters may be requested by the user via one or more inputs to the benchmarking system 10.

In some embodiments, the benchmarking system 10 may store the processed sustainability data in the memory (e.g., within a database) of the benchmarking system 10 or any other suitable memory to enable efficient retrieval and analysis of data at subsequent times. Further, in some embodiments, the benchmarking system 10 may incrementally develop and/or store the sustainability data after processing to facilitate efficient retrieval and analysis of the data at the subsequent times. In other embodiments, the AI engine 28 may store the processed sustainability data. In addition, a retrieval component of the AI engine 28 may be customized (e.g., via the one or more user inputs) to query the one or more data sources. Indeed, the retrieval component of the AI engine 28 may be customized to search, identify, and/or separate (e.g., partition) data based on an associated entity and/or industry based on one or more user queries.

In block 30, the benchmarking system 10 may receive a request to perform sustainability performance benchmarking and to generate a sustainability dashboard. For example, the user may input the request to perform sustainability performance benchmarking based on a desire to identify and/or visualize comprehensive sustainability data from the one or more data sources. Thus, the benchmarking system 10 may generate the sustainability dashboard based on the one or more subsets of sustainability data output via the AI engine 28 and template 32 associated with benchmarking. The template 32 may include processor-executable code that may be executed by the processor device of the benchmarking system 10. Moreover, the template 32 may specify a set of queries (e.g., targeted queries) in a sequence. In operation, the template 32 may be transmitted (e.g., sent) to the AI engine 28 of the benchmarking system 10 to cause deployment of the sustainability performance benchmarking.

Additionally or alternatively, the template 32 may define one or more parameters and/or visualization of the sustainability dashboard. In some embodiments, the user may define the one or more parameters via the one or more user inputs. The benchmarking system 10 may then present (e.g., display) the sustainability dashboard via a display (e.g., an electronic display) of the benchmarking system 10, or any other suitable display a part of or in communication (e.g., wired or wirelessly) with the benchmarking system 10, for visualization by the user. It should be noted that while one template 32 is illustrated in FIG. 1, multiple templates 32 may be present whereby each of the templates 32 are be linked (e.g., tied, connected) to generation of a particular sustainability dashboards that may be generated by the benchmarking system 10. For example, separate templates 32 may be generated for entities in separate industries. It should also be noted that while the benchmarking system 10 is described as receiving sustainability data, any other suitable type of data from any suitable industry may be received and employed by the benchmarking system 10 to determine performance benchmarking for the associated data. For example, the types of data may include sales data, operational data, financial data, or the like.

As described herein, the benchmarking system 10 may split and summarize the sustainability data to enable input into the AI engine 28 and/or storage of the sustainability data via the memory of the benchmarking system or a memory of the AI engine 28. With this in mind, FIG. 2 is a flowchart of a method 50 for providing a summarized one or more subsets of sustainability data for processing, in accordance with an embodiment of the present disclosure. It should be noted that one or more blocks of the method 50 need not necessarily be performed by the processing circuitry of the benchmarking system 10 and/or by the AI model (respectively) in the illustrated order. For example, one or more of the blocks of method 50 can be performed in parallel. Moreover, various blocks of the method 50 of FIG. 2 can be performed, for example, by the processing circuitry of the benchmarking system 10, which can operate in conjunction with a deep-learning processor or a neural-network processor and/or, for example, the processing circuitry may include machine learning and/or AI-based processors.

At block 52, the benchmarking system 10 may receive a set of sustainability data. For example, the benchmarking system 10 may receive the set of sustainability data via the one or more data sources, such as the one or more web links 14, the APIs 16, and/or the one or more databases 18. For example, the benchmarking system 10 may receive the set of sustainability data from block 20 after extraction of the sustainability data. At block 54, the benchmarking system 10 may split (e.g., divide, partition) the set of sustainability data into one or more subsets of sustainability data. In this manner, the AI model may receive and process each of the one or more subsets of sustainability data for summarization while maintaining each of the one or more subsets of sustainability data within capacity limits.

Further, at block 56, the benchmarking system 10 may assign an identifier (e.g., marker, tag) to each of the one or more subsets of sustainability data based on an associated data source (e.g., origin of the sustainability data, a respective entity). In some embodiments, the benchmarking system 10 may assign the identifier to each of the one or more subsets of sustainability data based on a type of the sustainability data, an industry associated with the sustainability data, and/or history of the sustainability data. Thus, assigning each of the subsets of sustainability data based on the associated data source, data type, industry, or historical context may enable the benchmarking system 10 to maintain organization and traceability of each of the subsets of sustainability data. That is, by assigning the identifiers, the benchmarking system 10 may efficiently organize and categorize the one or more subsets of sustainability data for retrieval and processing.

At block 58, the benchmarking system 10 may summarize the one or more subsets of sustainability data based on a template. Indeed, the benchmarking system 10 may summarize the one or more subsets of sustainability data by employing the AI model to perform summarization tasks. The benchmarking system 10 may employ the template based on a type of industry associated with the one or more sustainability reports included in the one or more subsets of sustainability data. The template may guide the AI model by providing a structured format for input data, such as the one or more subsets of sustainability data. Indeed, the template may enable the AI model to produce an expected output through pre-defined rules and/or patterns embedded within the template.

After performance of the summarization tasks, the benchmarking system 10 may obtain (e.g., receive) a representation of each sustainability report for each respective entity as a summary. As described herein, the template may be customized based on the one or more user inputs that specify a particular type of data to be summarized. As an example, the user may specify to summarize data associated with data plots. As another example, the user may specify to summarize data associated with climate solutions for each respective entity.

Moreover, the benchmarking system 10 may combine (e.g., concatenate, merge) each summary into a comprehensive summary of all of the subsets of sustainability data. As described herein, a data size (e.g., a token size) of the comprehensive summary may be within a maximum capacity of the AI model. At block 60, the benchmarking system 10 may provide the summarized one or more subsets of sustainability data for processing by the AI model. It should be noted that the benchmarking system 10 may perform the method 50 iteratively any suitable number of times. For example, the user may create the template that enables identification of sustainability data associated with a chemical industry and sustainability data associated with an oil and gas industry. The benchmarking system 10 may perform the method 50 based on a set of sustainability data associated with chemical industry. In addition, the benchmarking system 10 may perform the method 50 based on a set of sustainability data associated with the oil and gas industry. The benchmarking system 10 may then perform the method 50 on the resulting summarized one or more subsets of sustainability data associated with the chemical industry and the resulting summarized one or more subsets of sustainability data associated with the oil and gas industry to obtain the summarized one or more subsets of sustainability data for both industries.

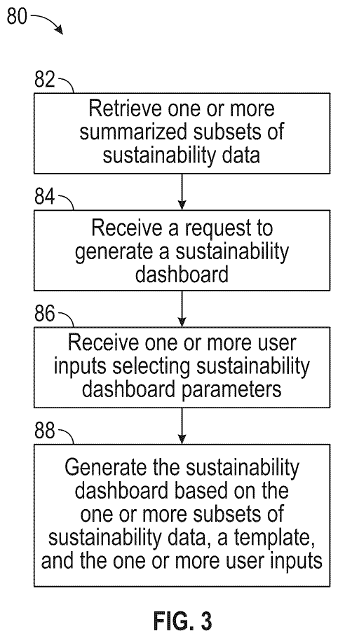

As described herein, the benchmarking system 10 may employ the summarized one or more subsets of sustainability data to perform sustainability performance benchmarking. FIG. 3 is a flowchart of a method 80 for generating a sustainability dashboard, in accordance with an embodiment of the present disclosure. It should be noted that one or more blocks of the method 80 may be performed by the processing circuitry of the benchmarking system 10 in any suitable order. For example, the processing circuitry of the benchmarking system 10 can operate in conjunction with a deep-learning processor or a neural-network processor and/or, for example, the processing circuitry may include machine learning and/or AI based processors.

At block 82, the benchmarking system 10 may retrieve the one or more summarized subsets of sustainability data (e.g., as described with respect to block 22 and FIG. 2). At block 84, the benchmarking system 10 may receive a request to generate the sustainability dashboard. For example, the benchmarking system 10 may receive the request to generate the sustainability dashboard from the user. Additionally, at block 86, the benchmarking system 10 may receive one or more user inputs selecting sustainability dashboard parameters. For example, the one or more sustainability dashboard parameters may include at least one of an entity name (e.g., company name), a scope one and two target, a scope three target, a net-zero date, a methane target, a flaring target, a sustainability budget, methane mitigation protocols, local carbon regulation, an investment review process, an executive leader for sustainability, a budget leader/team, a budget cycle for sustainability, an Oil and Gas Climate Initiative (OGCI) membership, an organization for sustainability, a product carbon intensity goal, a reporting standards alignment, and/or the like. In some embodiments, the benchmarking system 10 may provide (e.g., transmit, display) a set of queries to the user to enable the user to select the one or more sustainability dashboard parameters based on the set of queries.

At block 88, the benchmarking system 10 may generate the sustainability dashboard based on the one or more subsets of sustainability data, a template, and the one or more user inputs. For example, as described herein, the template may define at least some of the one or more dashboard parameters and/or visualization of the sustainability dashboard for sustainability performance benchmarking. As such, the benchmarking system 10 may efficiently generate and present (e.g., provide, display) the sustainability dashboard to the user. It should be noted that while the benchmarking system 10 is described herein as generating a sustainability dashboard, the benchmarking system 10 may generate any suitable number of sustainability dashboards, for example, respective sustainability dashboards for separate industries.

After the benchmarking system 10 has determined performance benchmarking for the associated data, the benchmarking system 10 may continuously update the performance benchmarking based on updated associated data (e.g., streamed or fetched from the one or more data sources). The benchmarking system 10 may then generate one or more alerts (e.g., notifications) to provide to the user based on the updates (e.g., changes) to the performance benchmarking. The one or more alerts may enable the benchmarking system 10 to inform the user of new data arrival and/or any updates (e.g., changes) in the one or more dashboard parameters. For example, the updates may include an increase, a decrease, or a determination of whether the updated associated data follows a particular pattern. In some embodiments, the benchmarking system 10 may generate the one or more alerts based on a user request. For example, the user may input a request to receive an alert if the scope one target of a respective entity changes while the budget of the respective entity decreases. The benchmarking system may provide the one or more alerts via the display of the benchmarking system 10, via a text message (e.g., a short message service (SMS) text) to a computing device (e.g., a mobile device, or any other suitable device) of the user, and/or via electronic mail (e-mail).

As an example, if the benchmarking system 10 determines that the budget of the respective entity increases (e.g., a capital expenditure or CapEx increase) by an amount (e.g., a large amount), the benchmarking system 10 may alert one or more users (e.g., business development managers) to enable the one or more users to explore opportunities tied to investment. As another example, if the benchmarking system 10 determine an increase in target scope (e.g., scope expansion), then the benchmarking system 10 may alert the one or more users to prompt engagement with subject matter experts and/or engineering teams. The subject matter experts and/or the engineering teams may provide assessment of abatement technologies and adjust existing decarbonization plans to align with the shift of objectives (e.g., to address the shift in target scope).

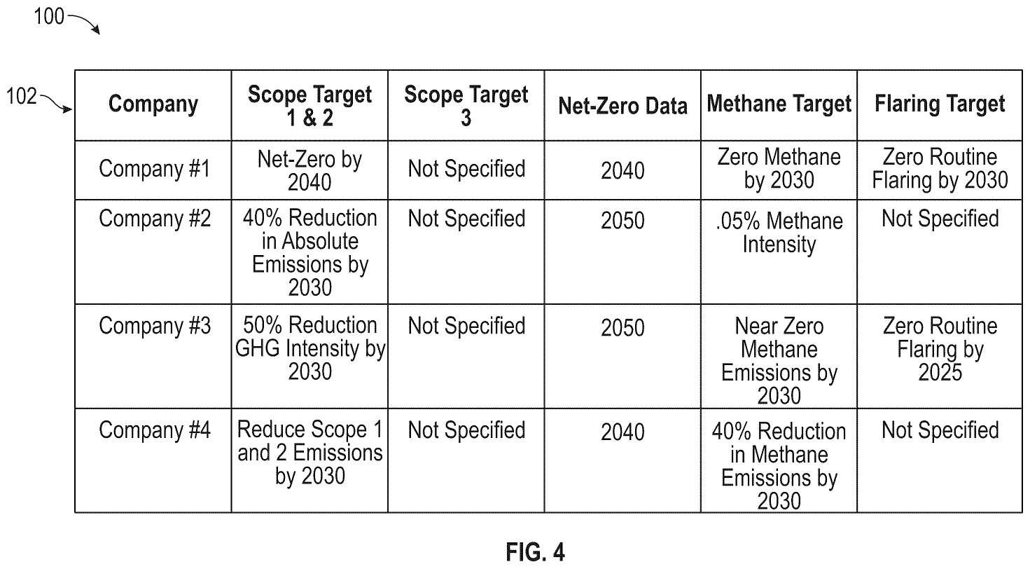

With the foregoing in mind, FIG. 4 is an example illustration of a sustainability dashboard 100, in accordance with an embodiment of the present disclosure. As illustrated in FIG. 4, one or more sustainability dashboard parameters 102 includes the company, the scope target one and two, the scope target 3, the net-zero date, the methane target, and the flaring target. However, it should be noted that, as described herein, the sustainability dashboard 100 may include any other suitable sustainability dashboard parameters 102. Accordingly, the benchmarking system 10 may enable the user to visualize a comprehensive visualization of the sustainability data and/or efficiently identify one or more sustainability metrics associated with one or more entities.

For example, the user may view the sustainability dashboard 100 to identify that a second company has a scope one target of a forty percent reduction in absolute emissions by 2030, a net-zero date of 2050, a near zero methane intensity by 2030, and a zero routine flaring by 2025. Further, the sustainability dashboard 100 may enable the user to identify a detailed real-time ranking and performance analysis of the one or more sustainability metrics associated with the one or more entities (e.g., each company). The fields of the sustainability dashboard 100 can also be tailored to particular users. For example, the fields can be tailored to include information about how much an entity has available to spend on sustainability initiatives, how soon the initiatives are to be implemented, etc. to aid in determining which entities are candidates for particular sustainability solutions. The fields can also be tailored to include, for example, standards that the entities are bound by, particular dates for goals and the like to aid in generating custom engineering targets and to provide guidance on what types of solutions would allow for reaching of sustainability targets of an entity. Similarly, for example, fields can be tailored to include information for competitors to ascertain their goals and progress in attaining sustainability. In this manner, the sustainability dashboard 100 provides a flexible platform to provide up to date information that can be tailored to particular users.

The technical effect of the disclosed embodiments includes an improvement in sustainability data management, summarization, and/or visualization. Indeed, the benchmarking system 10 efficiently benchmarks sustainability performance of the one or more entities by retrieving, extracting, splitting and summarizing, and/or processing the set of sustainability data to provide a comprehensive visualization of the sustainability data to the user via the sustainability dashboard 100. Further, the benchmarking system 10 may automatically collect the sustainability data from the one or more data sources and build a comprehensive database including the sustainability data for efficient retrieval and analysis at a subsequent time. The benchmarking system 10 may create dynamic and real-time benchmarks that account for one or more trends and/or one or more changes within at least one industry, while also providing the one or more entities with actionable insights.

The subject matter described in detail above may be defined as set forth below.

A tangible, non-transitory, computer-readable medium includes instructions that, when executed by processing circuitry, are configured to cause the processing circuitry to transmit a set of sustainability data to a computer vision model for extraction into a textualized set of sustainability data, divide the textualized set of sustainability data into one or more subsets of textualized sustainability data, transmit the one or more subsets of textualized sustainability data to an artificial intelligence (AI) model, transmit at least one instruction to the AI model to elicit summarization the one or more subsets of textualized sustainability data into a summarized dataset, and transmit at least one instruction to the AI model to cause generation of a sustainability dashboard including at least one metric selected from the summarized dataset.

The tangible, non-transitory, computer-readable medium of the preceding clause, wherein the instructions, when executed by the processing circuitry, are configured to cause the processing circuitry to receive the set of sustainability data from one or more data sources.

The tangible, non-transitory, computer-readable medium of any preceding clause, wherein the instructions, when executed by the processing circuitry, are configured to cause the processing circuitry to assign an identifier to each of the one or more subsets of textualized sustainability data based on its respective correlation to the one or more data sources.

The tangible, non-transitory, computer-readable medium of any preceding clause, wherein the instructions, when executed by the processing circuitry, are configured to cause the processing circuitry to receive the set of sustainability data from one or more web links, one or more Application Programming Interfaces, one or more databases, or any combination thereof as the one or more data sources.

The tangible, non-transitory, computer-readable medium of any preceding clause, wherein the instructions, when executed by the processing circuitry, are configured to cause the processing circuitry to transmit the at least one instruction to the AI model to elicit summarization of the one or more subsets of textualized sustainability data into the summarized dataset as including one or more sustainability reports.

The tangible, non-transitory, computer-readable medium of any preceding clause, wherein the instructions, when executed by the processing circuitry, are configured to cause the processing circuitry to receive one or more inputs associated with one or more sustainability dashboard parameters and transmit the one or more inputs to the AI model to cause generation of the sustainability dashboard based on the one or more inputs.

The tangible, non-transitory, computer-readable medium of any preceding clause, wherein the instructions, when executed by the processing circuitry, are configured to cause the processing circuitry to provide the sustainability dashboard for visualization as the graphical user interface.

The tangible, non-transitory, computer-readable medium of any preceding clause, wherein the instructions, when executed by the processing circuitry, are configured to cause the processing circuitry to generate one or more alerts based on one or more updates to the sustainability dashboard.

A method includes transmitting, via processing circuitry, a set of sustainability data to a computer vision model for extraction into a textualized set of sustainability data, dividing, via the processing circuitry, the textualized set of sustainability data into one or more subsets of textualized sustainability data, and transmitting, via the processing circuitry, the one or more subsets of textualized sustainability data to an artificial intelligence (AI) model. The method also includes transmitting, via the processing circuitry, at least one instruction to the AI model to elicit summarization of the one or more subsets of textualized sustainability data into a summarized dataset, and transmitting, via the processing circuitry, at least one instruction to the AI model to cause generation of a sustainability dashboard by the AI model as a graphical user interface on a display utilizing the summarized dataset, wherein the sustainability dashboard includes at least one metric selected from the summarized dataset.

The method of the preceding clause including receiving, via the processing circuitry, the set of sustainability data from one or more data sources.

The method of any preceding clause including assigning, via the processing circuitry, an identifier to each of the one or more subsets of textualized sustainability data based on its respective correlation to the one or more data sources.

The method of any preceding clause including transmitting, via the processing circuitry, the at least one instruction to the AI model to elicit summarization of the one or more subsets of textualized sustainability data into the summarized dataset as including one or more sustainability reports.

The method of any preceding clause including receiving, via the processing circuitry, one or more inputs associated with one or more sustainability dashboard parameters.

The method of any preceding clause including transmitting, via the processing circuitry, the one or more inputs to the AI model to cause generation of the sustainability dashboard based on the one or more inputs.

The method of any preceding clause including providing, via the processing circuitry, the sustainability dashboard for visualization as the graphical user interface.

The method of any preceding clause including generating, via the processing circuitry, one or more alerts based on one or more updates to the sustainability dashboard.

A system includes processing circuitry configured to transmit a set of sustainability data received from one or more data sources to a computer vision model for extraction into a textualized set of sustainability data, divide the textualized set of sustainability data into one or more subsets of textualized sustainability data, and transmit the one or more subsets of textualized sustainability data to an artificial intelligence (AI) model. The processing circuitry also configured to transmit at least one instruction to the AI model to elicit summarization the one or more subsets of textualized sustainability data into a summarized dataset and transmit at least one instruction to the AI model to cause generation of a sustainability dashboard including at least one metric selected from the summarized dataset.

The system of the preceding clause, wherein the processing circuitry is configured to assign an identifier to each of the one or more subsets of textualized sustainability data based its respective correlation to the one or more data sources.

The system of any preceding clause, wherein the processing circuitry is configured to receive one or more inputs associated with one or more sustainability dashboard parameters.

The system of any preceding clause, wherein the processing circuitry is configured to transmit the one or more inputs to the AI model to cause generation of the sustainability dashboard based on the one or more inputs.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

1. A tangible, non-transitory, computer-readable medium comprising instructions that, when executed by processing circuitry, are configured to cause the processing circuitry to:
transmit a set of sustainability data to a computer vision model for extraction into a textualized set of sustainability data;
divide the textualized set of sustainability data into one or more subsets of textualized sustainability data;
transmit the one or more subsets of textualized sustainability data to an artificial intelligence (AI) model;
transmit at least one instruction to the AI model to elicit summarization of the one or more subsets of textualized sustainability data into a summarized dataset; and
transmit at least one instruction to the AI model to cause generation of a sustainability dashboard by the AI model as a graphical user interface on a display utilizing the summarized dataset, wherein the sustainability dashboard comprises at least one metric selected from the summarized dataset.

2. The tangible, non-transitory, computer-readable medium of claim 1, wherein the instructions, when executed by the processing circuitry, cause the processing circuitry to receive the set of sustainability data from one or more data sources.

3. The tangible, non-transitory, computer-readable medium of claim 2, wherein the instructions, when executed by the processing circuitry, cause the processing circuitry to assign an identifier to each of the one or more subsets of textualized sustainability data based on its respective correlation to the one or more data sources.

4. The tangible, non-transitory, computer-readable medium of claim 2, wherein the instructions, when executed by the processing circuitry, cause the processing circuitry to receive the set of sustainability data from one or more web links, one or more Application Programming Interfaces, one or more databases, or any combination thereof as the one or more data sources.

5. The tangible, non-transitory, computer-readable medium of claim 1, wherein the instructions, when executed by the processing circuitry, cause the processing circuitry to transmit the at least one instruction to the AI model to elicit summarization of the one or more subsets of textualized sustainability data into the summarized dataset as comprising one or more sustainability reports.

6. The tangible, non-transitory, computer-readable medium of claim 1, wherein the instructions, when executed by the processing circuitry, are configured to cause the processing circuitry to:
receive one or more inputs associated with one or more sustainability dashboard parameters; and
transmit the one or more inputs to the AI model to cause generation of the sustainability dashboard based on the one or more inputs.

7. The tangible, non-transitory, computer-readable medium of claim 1, wherein the instructions, when executed by the processing circuitry, are configured to cause the processing circuitry to provide the sustainability dashboard for visualization as the graphical user interface.

8. The tangible, non-transitory, computer-readable medium of claim 1, wherein the instructions, when executed by the processing circuitry, are configured to cause the processing circuitry to generate one or more alerts based on one or more updates to the sustainability dashboard.

9. A method comprising:
transmitting, via processing circuitry, a set of sustainability data to a computer vision model for extraction into a textualized set of sustainability data;
dividing, via the processing circuitry, the textualized set of sustainability data into one or more subsets of textualized sustainability data;
transmitting, via the processing circuitry, the one or more subsets of textualized sustainability data to an artificial intelligence (AI) model;
transmitting, via the processing circuitry, at least one instruction to the AI model to elicit summarization of the one or more subsets of textualized sustainability data into a summarized dataset; and
transmitting, via the processing circuitry, at least one instruction to the AI model to cause generation of a sustainability dashboard by the AI model as a graphical user interface on a display utilizing the summarized dataset, wherein the sustainability dashboard comprises at least one metric selected from the summarized dataset.

10. The method of claim 9, comprising receiving, via the processing circuitry, the set of sustainability data from one or more data sources.

11. The method of claim 10, comprising assigning, via the processing circuitry, an identifier to each of the one or more subsets of textualized sustainability data based on its respective correlation to the one or more data sources.

12. The method of claim 9, comprising transmitting, via the processing circuitry, the at least one instruction to the AI model to elicit summarization of the one or more subsets of textualized sustainability data into the summarized dataset as comprising one or more sustainability reports.

13. The method of claim 9, comprising receiving, via the processing circuitry, one or more inputs associated with one or more sustainability dashboard parameters.

14. The method of claim 13, comprising transmitting, via the processing circuitry, the one or more inputs to the AI model to cause generation of the sustainability dashboard based on the one or more inputs.

15. The method of claim 9, comprising providing, via the processing circuitry, the sustainability dashboard for visualization as the graphical user interface.

16. The method of claim 9, comprising generating, via the processing circuitry, one or more alerts based on one or more updates to the sustainability dashboard.

17. A system comprising:
processing circuitry configured to:
transmit a set of sustainability data received from one or more data sources to a computer vision model for extraction into a textualized set of sustainability data;
divide the textualized set of sustainability data into one or more subsets of textualized sustainability data;
transmit the one or more subsets of textualized sustainability data to an artificial intelligence (AI) model;
transmit at least one instruction to the AI model to elicit summarization the one or more subsets of textualized sustainability data into a summarized dataset; and
transmit at least one instruction to the AI model to cause generation of a sustainability dashboard comprising at least one metric selected from the summarized dataset.

18. The system of claim 17, wherein the processing circuitry is configured to assign an identifier to each of the one or more subsets of textualized sustainability data based on its respective correlation to the one or more data sources.

19. The system of claim 17, wherein the processing circuitry is configured to receive one or more inputs associated with one or more sustainability dashboard parameters.

20. The system of claim 19, wherein the processing circuitry is configured to transmit the one or more inputs to the AI model to cause generation of the sustainability dashboard based on the one or more inputs.
